(19) United States
(12) Patent Application Publication
(10) Pub. No.: US 2023/0183072 A1
(43) Pub. Date: Jun. 15, 2023

(54) NANOFILLERS, MEMBRANES THEREOF, PREPARATION THEREOF, AND USE THEREOF

(71) Applicant: Qatar Foundation for Education Science and Community Development, Doha (QA)

(72) Inventors: Abed Alkader Alkhouzaam, Doha (QA); Hazim Qiblawey, Doha (QA)

(21) Appl. No.: 17/925,492

(22) PCT Filed: May 15, 2021
(86) PCT No.: PCT/QA2021/050009

§ 371 Date: Nov. 15, 2022

Related U.S. Application Data
(60) Provisional application No. 63/025,471, filed on May 15, 2020.

(51) Int. Cl. C01B 32/198; B01D 67/00; B01D 69/14; B01D 71/68; B01D 71/02; B01D 71/44

(52) U.S. Cl. CPC C01B 32/198; B01D 67/00793; B01D 69/148; B01D 71/68; B01D 71/0211; B01D 71/441; B01D 2323/21819; B01D 2323/60

(57) ABSTRACT

A high-oxidation and NOx-free synthesis of graphene oxide (GO) from natural graphite using the modified Hummers' method is described. The amine-functionalized GO using dodecylamine (DDA) is used as a filler for membranes for the first time. Antifouling and antibacterial properties of UF membranes are achieved using amine functionalization of GO. A process of incorporating raw GO and dodecylamine-functionalized GO (GO-DDA) in polysulfone (PSF) via phase inversion technique is disclosed.

### PRIORITY

The present application claims priority to U.S. Ser. No. 63/025,471, filed May 15, 2020, the entire contents of which are being incorporated herein by reference.

### BACKGROUND

The limitation of water resources with the huge increase in population generate a critical problem to water security globally and suitable solutions must be developed to align consumption and supply over time while protecting water quality. Several technologies have been developed over the years to provide alternative water supplies by wastewater treatment and seawater desalination. These technologies include distillation, membrane filtration, ion exchange, and aqueous adsorption. The selection and use of these technologies throughout the world depend on the power requirements, availability of resources, contamination, and economic factors. Therefore, cost and power efficient technologies need to be developed for desalination and wastewater treatment.

Membrane treatment for desalination and wastewater is one of the promising solutions to produce affordable clean water. Developing novel membranes was the focus of most studies in water treatment and desalination sector to find new materials that can improve the separation efficiency while reducing membrane fouling which is the most important challenge in this field. Fouling is a process where contaminants in feed water deposit onto membrane surface or within the membrane pores, consequently causing flux decline and lowering the permeate quality (filtration capacity), reduces membrane lifetime leading to an increase in the operational costs.

Fouling can be divided into four main categories depending on the type of foulant in the feed: colloidal fouling, biofouling, scaling, and organic fouling. Although the performance of fouled membranes can be moderately restored by various washing methods, the operation difficulties and costs are inevitably increased. Therefore, different membrane materials and modifications have been investigated over the years to produce antifouling membranes with better flux and rejection properties.

The use of nanotechnology is one of the well investigated methods being developed in membrane sector. The addition of nanomaterial (filler) to conventional membranes enhances their properties (e.g., antifouling, flux, rejection, etc.). Several nanomaterials have been used as membrane fillers and showed excellent performance. One of the recently investigated nanomaterials in membrane science for water treatment and desalination is graphene oxides (GO). Because of its high mechanical strength, easy accessibility, and chemical stabilities, GO is considered as one of the promising fillers that can reduce the fouling of membranes while enhancing their performance with respect to water flux and salt rejection.

Graphite can be oxidized to GO using several approaches. Brodie's method reported in 1859 was the first one using nitric acid (HNO₃) and potassium chlorate (KClO₃) as the intercalant and oxidant. However, several drawbacks associated with this approach have been reported. In 1958, Hummers eliminated the flaws associated with Brodie's method by using sulfuric acid (H₂SO₄) with Sodium nitrate (NaNO₃) and Potassium permanganate (KMnO₄) to oxidize graphite. However, the formation of toxic gases (e.g., NO₂ and N₂O₂) due to the use of NaNO₃ and the formation of graphite-GO mixture due to the incomplete oxidation of graphite are considered the main flaws of Hummers' method. The synthesis of GO from graphite simply goes through two steps, the oxidation of graphite to GO and then washing and purification of GO from impurities (acids, manganese salts, etc.). FIG. 2 illustrates the main steps of GO synthesis via Hummers' method.

### SUMMARY

In this disclosure, a high-oxidation and NOx-free synthesis of graphene oxide (GO) from natural graphite using the modified Hummers' method is described. The amine-functionalized GO using dodecylamine (DDA) is used as a filler for membranes for the first time. The present disclosure achieves antifouling and antibacterial properties of UF membranes using amine functionalization of GO. The present disclosure also provides a process of incorporating raw GO and dodecylamine-functionalized GO (GO-DDA) in polysulfone (PSF) via phase inversion technique.

According to one non-limiting aspect of the present disclosure, GO may be synthesized with high oxygen content and NOx-free emissions starting from natural graphite flakes.

According to another non-limiting aspect of the present disclosure, a functionalization process of GO with DDA may use a temperature assisted flux technique.

According to another non-limiting aspect of the present disclosure, a material may be prepared from the above processes, the material comprising GO-DDA.

According to another non-limiting aspect of the present disclosure, a PSF-GO-DDA membrane may be prepared by incorporating the GO-DDA into the polymer PSF.

According to another non-limiting aspect of the present disclosure, a membrane GO-DDA-0.1 may be synthesized by incorporating into PSF 0.1 wt. % of the GO-DDA.

Additional features and advantages are described herein and will be apparent from the following Detailed Description and the figures.

### BRIEF DESCRIPTION OF THE DRAWINGS

FIG. 1 illustrates types of membrane fouling.

FIG. 2 illustrates oxidation of graphite via conventional Hummers' method.

FIG. 3 is an illustration of the GO synthesis procedures.

FIG. 4 is schematic representation of the functionalization reaction of GO with DDA.

FIG. 5 are photographs of the prepared casting solutions with different loadings of GO and GO-DDA.

FIG. 6 is an illustration of the GO based MMMs preparation using phase inversion.

FIG. 7 shows FTIR spectra of DAA, the functionalized GO (GO-DDA) and the original GO.

FIGS. 8 (a) and 8 (b) are an illustration of Raman spectra deconvolution and peaks fitting for (a) GO and (b) GO-DDA.

FIG. 9 are scanning electron microscope (SEM) images of GO and GO-DDA.

FIG. 10 shows TGA curves (solid lines) of the GO samples and the corresponding derivative curves (dotted lines).

FIG. 11 are photographs of GO and GO-DDA dispersions in various solvents (0.5 mg·mL⁻¹).

FIG. 12 is FTIR-UATR spectra of PSF, GO-1.5, and GO-DDA-1.5.

FIG. 13 are SEM images of PSF with different loadings of GO.

FIG. 14 are SEM images of PSF with different loadings of GO-DDA.

FIG. 15 are cross-section SEM images (10,000× magnification) of PSF, GO-0.02, and GO-DDA-0.02 showing pores filling by nanomaterial.

FIG. 16 are AFM images of images of the PSF, GO and GO-DDA based membranes (scanning area of 5×5 μm).

FIG. 17 shows contact angle of the prepared membranes.

FIG. 18 shows overall porosity and mean pore size of the prepared membranes.

FIG. 19 shows separation performance of the prepared membranes.

FIG. 20 shows photographs of samples from the feed and permeate during HA filtration measurements. ABS is the absorbance value obtained by UV.

FIG. 21 shows Flux recovery rate (FRR %) of the tested membranes after BSA and HA fouling.

FIG. 22 shows BSA fouling resistance of the tested membranes.

FIG. 23 shows HA fouling resistance of the tested membranes.

FIG. 24 are SEM images of PSF, GO-0.05 and GO-DDA-0.15 after BSA fouling (10,000× magnification at two different locations of each membrane).

FIG. 25 are SEM images of PSF, GO-0.15 and GO-DDA-0.1 after HA fouling (10,000× magnification at two different locations of each membrane).

FIG. 26 shows microphotographs of PSF, GO-0.15 and GO-DDA-0.1 after HA fouling at different locations of each membrane (scale bar is 300 μm).

FIG. 27 shows antibacterial activity of pristine PSF, GO-0.15, and GO-DDA-0.15.

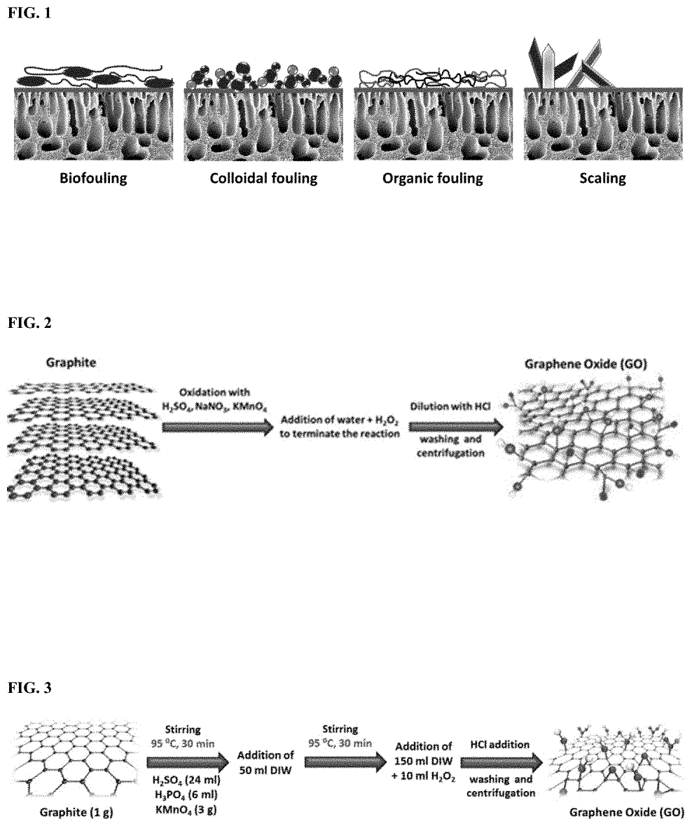

### DETAILED DESCRIPTION

All percentages are by weight of the total weight of the composition unless expressed otherwise. Similarly, all ratios are by weight unless expressed otherwise. When reference is made to the pH, values correspond to pH measured at 25° C. with standard equipment. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used herein and in the appended claims, the singular form of a word includes the plural, unless the context clearly dictates otherwise. Thus, the references “a,” “an” and “the” are generally inclusive of the plurals of the respective terms. For example, reference to “an ingredient” or “a method” includes a plurality of such “ingredients” or “methods.” The term “and/or” used in the context of “X and/or Y” should be interpreted as “X,” or “Y,” or “X and Y.”

Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” is also a disclosure of embodiments “consisting essentially of” and “consisting of” the disclosed components. Where used herein, the term “example,” particularly when followed by a listing of terms, is merely exemplary and illustrative, and should not be deemed to be exclusive or comprehensive. Any embodiment disclosed herein can be combined with any other embodiment disclosed herein unless explicitly indicated otherwise.

The present disclosure provides a synthesis method of dodecylamine-functionalized graphene oxide (GO) as high-antifoulant and antibacterial nanofiller for membrane-based water treatment. The present disclosure provides a high-oxidation and NOx-free synthesis of GO from natural graphite using modified Hummers' method. The inventors use amine-functionalization of the GO using dodecylamine (DDA) to be used as a filler for membranes. The inventors investigated the effect of amine functionalization of GO on the antifouling and antibacterial properties of UF membranes. The incorporation of raw GO and dodecylamine-functionalized GO (GO-DDA) in polysulfone (PSF) via phase inversion technique is also disclosed. Additionally, antifouling against protein and organic foulants and antibacterial measurements are also investigated.

The oxygen content in the functional groups (e.g., hydroxyls, carboxyls, ketones and epoxides) located on the edges of GO sheets causes its hydrophilic properties and make the surface modifications easier to derive other graphene-based materials. Furthermore, GO can be easily exfoliated in polymer matrix (e.g., polysulfone (PSF), polyethersulfone (PES), polyvinylidene fluoride (PVDF), etc.) and polar aprotic solvents which makes a good candidate to be utilized as nanofiller in membranes fabrication sector.

The efficient utilization of nanofillers in membranes fabrication depends on the better interfacial interaction between polymeric matrix and the nanofiller as well as the uniform and stable dispersion in the matrix. However, pristine nanoparticles like GO cannot achieve stable and uniform dispersion which limits the efficiency of using them as fillers in polymeric matrices. Graphene oxide properties can be significantly enhanced by a successful functionalization for different applications. Among the various functional groups investigated in nanoparticles modification, amines were found to improve interactions between the nanofiller and polymeric matrix leading to an enhancement of membranes mechanical properties as well as their fouling resistance and antibacterial activity.

The present disclosure provides (i) new development on the conventional Hummers' method to synthesize GO with high oxygen content and NOx-free emissions starting from natural graphite flakes and the reaction conditions; (ii) GO and DDA synthesized using temperature assisted flux technique; (iii) the resulted material, GO-DDA, incorporated into the polymer PSF to from novel PSF ultrafiltration membranes; (iv) high dispersibility of GO-DDA in various organic solvents; and (v) a novel membrane, GO-DDA-0.1 synthesized by incorporating 0.1 wt. % of the new nanofiller, GO-DDA, into PSF.

The present disclosure provides new modified Hummers' method for the synthesis of graphene oxide (GO) with high oxidation degree and without NOx emissions. The synthesized GO was characterized using several analytical techniques and showed high oxygen content compared to available GO particles.

The present disclosure describes the amine functionalization of GO using dodecylamine (DDA) to form functionalized GO (GO-DDA) with high antifouling and antibacterial properties. It describes also its first use as nanofiller in membrane technology.

The incorporation of GO-DDA into PSF lowers the surface roughness of the membrane leading to higher antifouling properties.

The best performance of the membrane was observed when using 0.1 wt. % GO-DDA in PSF. Fouling resistance represented by flux recovery ratio (FRR) was elevated by 37.8% against protein fouling (BSA); and by 13.1% against organic fouling (HA). Antibacterial activity represented by bacteriostasis rate (BR) was increased by 32.9% when using GO-DDA instead of using the pristine GO.

The present disclosure confirms the possibility of using GO-DDA as nanofiller for different types of membranes including UF, NF and RO due to its high dispersibility in several organic solvents.

In one aspect, the present disclosure provides a process of synthesizing graphene oxide (GO) with high oxygen content and NOx-free emissions starting from natural graphite flakes. For example, the process may comprise mixing sulfuric acid (H2SO4) and phosphoric acid (H3PO4), adding graphite powder and potassium permanganate (KMnO4), transferring the mixture to an oil bath, adding deionized water (DIW) to the mixture, adding H₂O₂, cooling down the mixture at room temperature, diluting the mixture with a HCl solution, and performing centrifugation.

In one embodiment, the process may comprise one or more steps selected from the group consisting of: mixing sulfuric acid (H₂SO₄) and phosphoric acid (H₃PO₄) in a ratio of about 10:1 to 0.25:1, for example, about 4:1 (v/v); stirring in an ice bath for several (e.g., 1-10) minutes; adding about 0.1-10 g, for example, about 1 g of graphite powder and about 0.1-10 g, for example, about 3 g of potassium permanganate (KMnO4) slowly; transferring a mixture to an oil bath at about 95±2° C. for about 10-60 minutes, for example, 30 minutes; adding about 10-100 ml, for example, about 50 ml of deionized water (DIW) to the mixture; stirring for about 10-60 minutes, for example, about 30 minutes; placing the mixture in an cold bath, for example, an ice bath; adding about 50-250 ml, for example, about 150 ml of DI and about 1-20 ml, for example, about 10 ml of H₂O₂ to the mixture; cooling down the mixture at room temperature; diluting the mixture with about 10-30%, for example, about 20% HCl solution; performing centrifugation at about 5000-10000 rpm, for example, about 7500 rpm for about 10-30 minutes, for example, about 20 minutes; removing supernatant from the mixture; washing residual with, for example, deionized water; repeating centrifugation until pH becomes neutral; and drying, for example, in oven at about 65-95° C., for example, about 80° C. for about 24-60 hours, for example, about 48 hours.

In one aspect, the present disclosure provides a functionalization process of GO with dodecylamine (DDA) using a temperature assisted flux technique. For example, the process may comprise dispersing GO in DIW and DDA in ethanol to form suspensions, sonicating the suspensions, and extracting a functionalized GO (GO-DDA).

In one embodiment, the process may comprise one or more steps selected from the group consisting of: dispersing about 50-200 mg, e.g., 100 mg of GO in about 30-70 ml, e.g., about 50 ml of DIW; dispersing about 200-400 mg, e.g., about 300 mg of DDA in about 30-70 ml, e.g., about 50 ml of ethanol; sonicating the prepared suspensions/solutions in, e.g., a bath sonicator for about 0.5-2 hours, e.g., about 1 hour; transferring both GO and DDA suspensions to, e.g., a round bottom flask; stirring at about 50-70° C., e.g., about 60° C. for about 24-60 hours, e.g., about 48 hours in, e.g., an oil bath, under reflux conditions; extracting functionalized GO (GO-DDA) by, e.g., solvent evaporation technique; washing extracted GO-DDA, e.g., with ethanol; and drying the GO-DDA, e.g., under vacuum, and/or at about 75-95° C., e.g., about 85° C., and/or at least about 10 hours, e.g., overnight.

In one aspect, the present disclosure provides a preparation process of a polysulfone (PSF)-GO-DDA membrane prepared by incorporating GO-DDA into the polymer PSF. For example, the process may comprise adding GO-DDA to 1-Methyl-2-pyrrolidinone (NMP) to form a mixture, mixing polyvinylpyrrolidone (PVP) and polysulfone (PSF) in the mixture, and casting the mixture to form the membrane, wherein the membrane comprises PSF-GO-DDA.

In one embodiment, the process may comprise one or more steps selected from the group consisting of: adding GO-DDA to 1-Methyl-2-pyrrolidinone (NMP); dispersing mixture, e.g., by ultra-sonication, for about 1-3 hours, e.g., about 2 hours; stirring the mixture at, e.g., room temperature; loading polyvinylpyrrolidone (PVP) (about 1-5 wt. %, e.g., about 3 wt. % PVP in NMP) and PSF (about 15-20 wt. %, e.g., about 17 wt. % PSF in NMP) to the mixture; stirring the mixture at, e.g., room temperature for at least 5 hours, e.g., overnight; casting the mixture on a flat surface, e.g., on a glass plate; dipping casted mixture, e.g., into DIW; washing the casted mixture several times, e.g., in DIW; and storing the casted mixture in DIW.

In some embodiments, the PSF-GO-DDA membrane may be prepared using about 0.01-1 wt. %, e.g., about 0.1 wt. % GO-DDA in PSF.

In some embodiments, the GO-DDA may comprise at least one functional group selected from the group consisting of C—O—C, C—OH, C═O, and C═C. The functional groups in the GO may have at least one of the following characteristics: epoxy C—O—C stretching vibration (˜1030-1050 cm-1), C—OH bending vibrations of the hydroxyl groups (˜1235 cm-1), C══O stretching vibration of the carbonyl functional groups on the edge of GO sheets (˜1705 cm-1), C══C skeletal vibration from unoxidized graphene (˜1600-1620 cm-1), and O—H stretching vibrations corresponding to residual water intercalated between the GO sheets (˜3200 cm-1).

In some embodiments, the PSF-GO-DDA membrane may comprise at least one functional group selected from the group consisting of C—S—O, C—O—C, S═O, and C—C aromatic ring. The functional groups in the PSF-GO-DDA membrane may have at least one of the following characteristics: O—S—O symmetric stretching (˜1150 cm⁻¹), C—O—C stretching (˜1242 cm⁻¹), S══O stretching (˜1294 cm⁻¹), O—S—O asymmetric stretching (˜1320 cm⁻¹), C—C aromatic ring stretching (˜1488, 1588 cm⁻¹), and aromatic ring breathing (˜1660 cm⁻¹).

In some embodiments, the PSF-GO-DDA membrane has a higher antifouling and antibacterial activity properties than the PSF membrane.

In some embodiments, the PSF-GO membrane has a higher hydrophilicity than the PSF membrane and the PSF-GO-DDA membrane.

In some embodiments, the PSF-GO-DDA membrane has a smoother surface than the PSF membrane and the PSF-GO membrane.

In some embodiments, the PSF-GO membrane and the PSF-GO-DDA membrane has a smaller mean pore size than the PSF membrane.

In some embodiments, the PSF-GO membrane and the PSF-GO-DDA membrane has a lower pure water permeability (PWP) than the PSF membrane, and the PSF-GO-DDA membrane has a lower PWP than the PSF-GO membrane.

The PSF-GO membrane and the PSF-GO-DDA membrane has a higher flux recovery ratio (FRR) than the PSF membrane, and the PSF-GO-DDA membrane has a higher FRR than the PSF-GO membrane.

The main advantages of the disclosed GO synthesis include the replacement of HNO₃ with H₃PO₄ which avoid the formation of acid fog associated with the use of HNO₃; much less reaction time (e.g., 1 hour); and much lower synthesis cost, compared to existing methods.

The advantages of the disclosed functionalization with DDA include the direct functionalization of GO with DDA which gives good degree of functionalization; and using the GO-DDA with various types of membranes.

The testing conditions used in the present study are more reliable due to the use of cross-flow system (compared to dead-end) and longer time to allow fouling to occur properly. Also, the use of two types of foulants provides better evaluation of antifouling properties of the disclosed membranes. The disclosed membrane has the antibacterial activity.

### EXAMPLES

### Example 1: Graphene Oxide Preparation

Graphene oxide has been synthesized using slight variations on the conventional Hummers' method by excluding the use of NaNO₃ and changing the ratios of the reactants. In brief, 24 ml of sulfuric acid (H₂SO₄) and 6 ml of phosphoric acid (H₃PO₄) (volume ratio 4:1) were mixed and stirred in an ice bath for several minutes. Then 1 g of graphite powder and 3 g of potassium permanganate (KMnO₄) were added slowly into mixing solution under stirring condition. The mixture was then transferred to an oil bath at 95±2° C. for 30 minutes. 50 ml of deionized water (DIW) was then added and the mixture was kept under stirring for 30 minutes. The mixture was then placed in an ice bath and 150 ml of DI and 10 ml of H₂O₂ were added slowly to terminate the reaction. The exothermic reaction occurred and the solution was kept at room temperature to cool down. The resulted solution was then diluted with 20% HCl solution and centrifuged using Centrifuge at 7500 rpm for 20 minutes. Then, the supernatant was removed away and the residual was then washed with deionized water and centrifuged for several times until the pH became neutral. Finally, the prepared sample was dried in oven at 80° C. for about 48 hours. FIG. 3 illustrates the oxidation procedures of graphite to GO.

### Example 2: Functionalization of GO with Dodecylamine

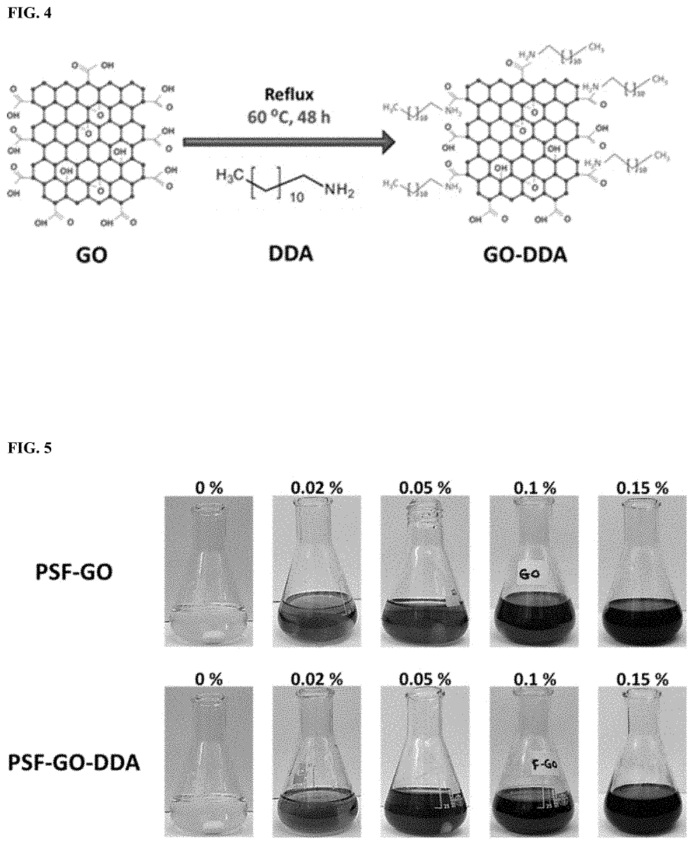

The functionalization of GO with DDA was conducted using the temperature-assisted reflux technique. In brief, 100 mg of GO were dispersed in 50 ml of deionized water (DIW) and 300 mg of DDA were dispersed in ethanol (50 ml). Both solutions were then sonicated in a bath sonicator for 1 hour. Both GO and DDA suspensions were transferred to a round bottom flask and stirred at 60° C. for 48 hours in an oil bath under reflux conditions. The functionalized GO (GO-DDA) was then extracted by solvent evaporation technique followed by several washings with ethanol. The resulted product was in form of fine powders and was dried under vacuum at 85° C. overnight. A schematic representation of the functionalization reaction and the expected chemical structure of GO-DDA is presented in FIG. 4.

### Example 3: Membranes Fabrication

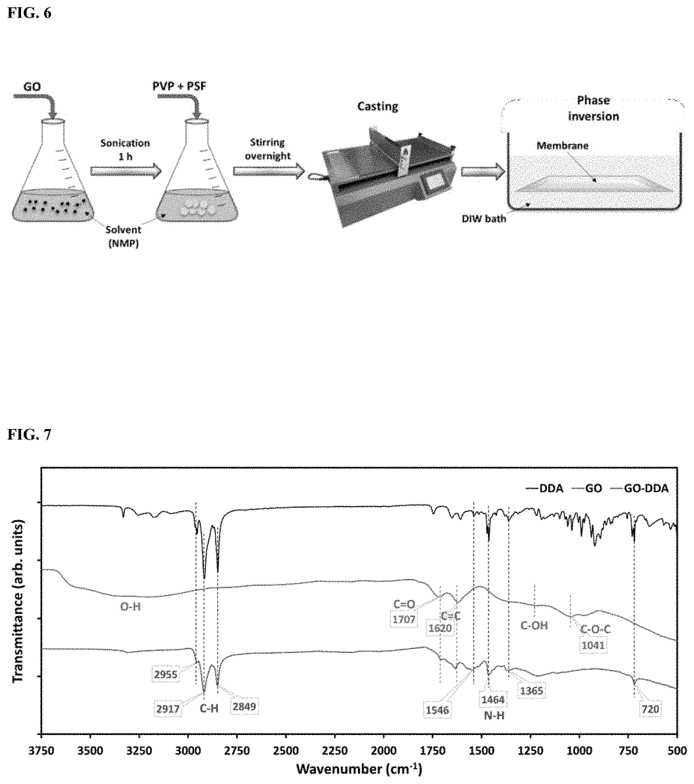

The preparation of PSF, GO and GO-DDA based UF membranes was conducted using the phase inversion technique. A 17 wt. % PSF in NMP was used as the casting solutions with PVP (3 wt. % in NMP) as pores forming agent. First, different concentrations of GO and GO-DDA (with respect to PSF weight) were added to the NMP solvent and dispersed by ultra-sonication for about 2 hours. GO-NMP and GO-DDA-NMP suspensions were then stirred under room temperature. PVP and PSF were then loaded slowly to the solution and kept under stirring conditions overnight to assure complete dissolving of the polymer. The resulted homogenous solution (FIG. 5) was then casted on a glass plate. The casted solution was then dipped into DIW after casting to allow ideal phase inversion. Theses membranes were washed several times and stored in DIW until usage. FIG. 6 illustrates the phase inversion process for GO based UF membranes preparation. The compositions and codes of the prepared membranes are presented in Table 1.

TABLE 1
GO and GO-DDA compositions in the prepared membranes

| Membrane | GO (wt. % in PSF) | GO-DDA (wt. % in PSF) |
|---|---|---|
| PSF | — | — |
| GO-0.02 | 0.02 | — |
| GO-0.05 | 0.05 | — |
| GO-0.1 | 0.1 | — |
| GO-0.15 | 0.15 | — |
| GO-DDA-0.02 | — | 0.02 |
| GO-DDA-0.05 | — | 0.05 |
| GO-DDA-0.1 | — | 0.1 |
| GO-DDA-0.15 | — | 0.015 |

### Example 4: Characterization of GO and GO-DDA

The prepared GO and GO-DDA were characterized using several techniques to investigate the contribution of oxidation conditions as well as the functionalization reaction to the properties of both samples. CHNSO elemental analysis was conducted using Thermo Scientific™ FLASH 2000 elemental analyzer. Fourier Transform Infrared Spectroscopy—universal attenuated total reflectance sensor (FTIR-UATR) spectra was determined in the range of 400-4000 cm⁻¹ using FTIR Perkin Elmer 2000. The FTIR analysis was carried out for interpretation of the surface functional groups of GO samples prepared at different reaction conditions. Raman spectra were recorded at room temperature using DXR Raman Spectrometer from Thermo Scientific equipped with a 532 nm laser and a 10× objective. Moreover, GO and GO-DDA morphology was evaluated using scanning electron microscopy (SEM) using JEOL model JSM-6390LV. Thermogravimetric analysis (TGA) was performed to evaluate the thermal stability of GO using PerkinElmer thermogravimetric analyzer (Pyris 6 TGA) under nitrogen over temperature range of 30-800° C. at a heating rate of 10° C./min.

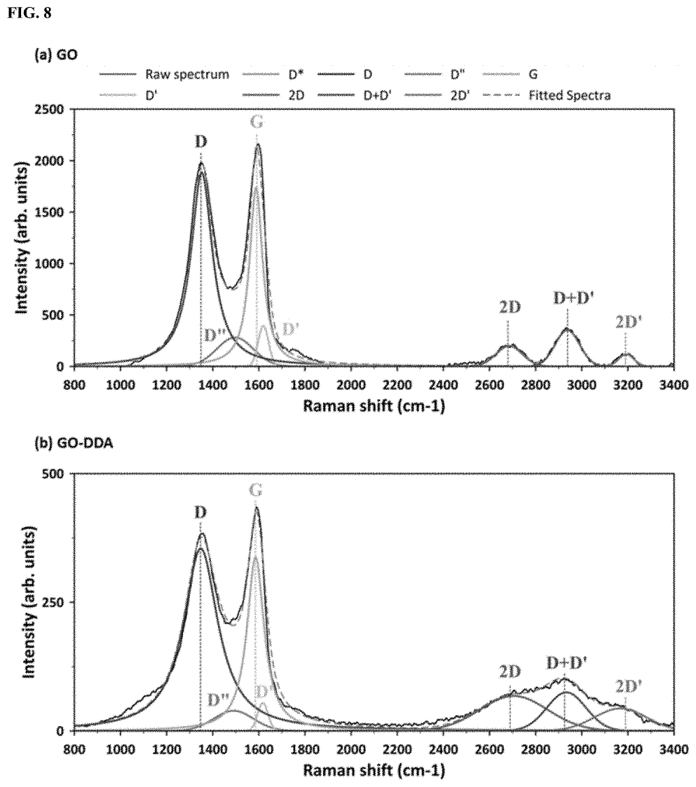

The FTIR spectra of the DDA, GO, and GO-DDA are presented in FIG. 7. The spectra of the prepared GO confirm the oxidation of graphite due to the presence of several bands attributed to oxygen functionalization. The following functional groups were identified in the spectra of the prepared GO:

epoxy C—O—C stretching vibration (˜1030-1050 cm-1), C—OH bending vibrations of the hydroxyl groups (˜1235 cm⁻¹), C══O stretching vibration of the carbonyl functional groups on the edge of GO sheets (˜1705 cm⁻¹), C══C skeletal vibration from unoxidized graphene (˜1600-1620 cm⁻¹), and O—H stretching vibrations corresponding to the residual water intercalated between the GO sheets (˜3200 cm⁻¹). The spectra of GO-DDA confirms also the functionalization of GO with the DDA by the presence of several bands at 2955, 2917, 2849, 1546, 1464, 1365, and 720 cm⁻¹. It was found that the C══O band was reduced with functionalized GO due to the reduction of the oxygen along with the alkyl chain addition to the GO structure. The elemental analysis results (Table 2) shows good degree of graphite oxidation as well represented by the high oxygen content and O/C ratio (50% and 1.1 respectively). However, the GO functionalization with DDA reduced its oxygen content to about 12.3 wt. % and increased C, N and H compositions to about 77.4, 3.8 and 6.5 wt. % respectively due to the addition of the alkyl chain which agrees with the FTIR analysis.

TABLE 2
Elemental compositions of the prepared GO and GO-DDA size

| | Elemental analysis (wt. %) | | | | | |
|---|---|---|---|---|---|---|
| Sample | % N | % C | % H | % S | % O | O/C |
| GO | 0.3 | 46.7 | 2.6 | 0.3 | 50.0 | 1.1 |
| GO-DDA | 3.8 | 77.4 | 6.5 | 0.0 | 12.3 | 0.2 |

Raman spectroscopy is an essential tool for the characterization of graphene-based materials. A good analysis of the Raman spectra provides quantitative and qualitative information about the properties of GO such as crystallite size, defects and number of layers. Raman spectra of the prepared GO and GO-DDA are shown in FIGS. 8(a) and 8(b). The two characteristic bands for graphene-based materials, D and G, are presented in both spectra at ˜1350 and ˜1590 cm⁻¹ respectively, in addition to second-order bands (˜2500-3200 cm⁻¹) due to second order phonon processes. It is well-known that the first-order bands are related to the crystallite size of graphene oxides. Therefore, the first order spectra were deconvoluted and fitted into 4 peaks, D, D″, G, and D′. Several studies found that the in-plane sp² crystallite size (Lₐ) is inversely proportional to the ratio of D and G intensities (I_{D}/I_{G}). Hence, the relative intensities of the D and G bands have been calculated from fitted spectra and used to estimate the crystallite size. The crystallite size Lₐ (nm) was then estimated using Tuinstra-Koenig model:

$${L}_{a} = ( 2.4 \times {10}^{- 10} ) {{λ}^{4} ( \frac{{I}_{D}}{{I}_{G}} )}^{- 1} \qquad ( 3 )$$

Where λ is the laser wavelength (nm), ID and IG are the integrated intensities under the D and G bands respectively. Bands parameters estimated from the first-order spectra fits and the estimated crystallite sizes of GO and GO-DDA are presented in Table 3.

TABLE 3
D and G bands' parameters of Raman
spectra and the estimated crystallite size

| | | Peak center | Peak area | | La |
|---|---|---|---|---|---|
| GO sample | Curve | cm⁻¹ | arb. units | ID/IG | (nm) |
| GO | D | 1352 | 334053 | 1.8 | 10.9 |
| | G | 1588 | 189857 | | |
| GO-DDA | D | 1348 | 101428 | 2.1 | 9.2 |
| | G | 1586 | 48374 | | |

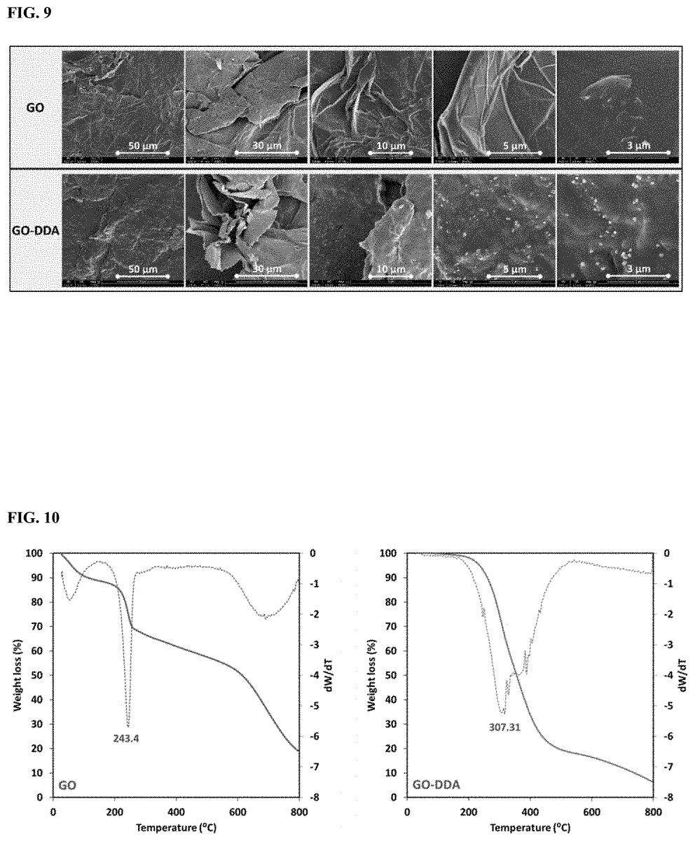

SEM images of GO and GO-DDA at different magnifications are presented in FIG. 9. SEM images shows clear difference in the morphological characteristics of GO and GO-DDA. Images of the unfunctionalized GO shows clear, sharp and smoother flakes while the surface became rough with irregular structure with DDA addition. SEM images at high magnifications show clear attachment of DDA on the surface of GO sheets confirming a successful functionalization of GO. In summary, all characterization techniques confirm the incorporation of DDA on the GO surface which is expected to enhance the separation performance in water treatment as well as the antibacterial and antifouling properties of GO.

TGA analysis was conducted to investigate the thermal stability of GO and GO-DDA. FIG. 10 shows the TGA curves of the prepared GO and their corresponding derivatives. TGA curve of raw GO exhibit 3 steps of weight loss:

a slight weight loss before 100° C. resulted from the evaporation of water trapped between GO sheets, a major weight loss between 200 and 400° C. resulted from the thermal degradation of unstable oxygen containing functional groups (hydroxyl, epoxy and carboxyl), and a final step attributed to the decomposition of most stable groups at higher temperatures. GO-DDA exhibits different thermal stabilities when compared to the raw GO. No weight loss was observed before 100° C., which indicates a hydrophobic nature of GO-DDA that resists water to be attached to its surface during functionalization. The major degradation of unstable oxygen containing groups occurred around 243° C. and 307° C. for GO and GO-DDA respectively as depicted by the derivative curves. The difference in weight loss of GO samples is mainly caused by their elemental compositions as the thermal decomposition of GO depends on the bond dissociation energies that is ordered as follow: H-bonding<C-O—C<COOH, HO—C—C—OH<C-C<C═C.

### Example 5: Dispersion Studies of GO and GO-DDA

To investigate their dispersion properties, both GO and GO-DDA were dispersed in DIW and different organic solvents including, hexane, DMA, DMF, dodecane, toluene and NMP. The dispersion tests were performed in ultrasonic bath for 2 hours at room temperature and concentration of 0.5 mg·mL⁻¹.

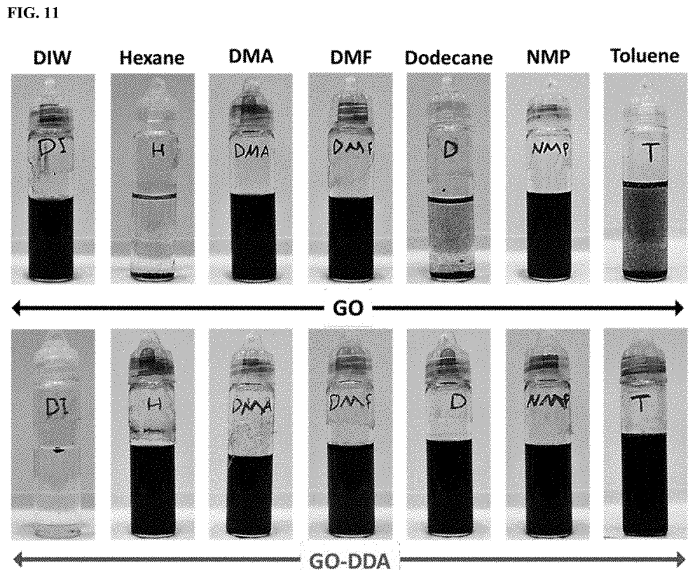

Photographs of GO and GO-DDA dispersions just after sonication are shown in FIG. 11. GO showed good degree of dispersion in DIW, DMF, DMA and NMP. However, in dodecane, toluene and hexane, the dispersion was very poor. In contrast, GO-DDA showed good dispersion in all solvents except in DIW. The poor dispersion of GO-DDA in DIW can be related to the reduction of the oxygen along with the alkyl chain addition to the GO structure, which reduces the hydrophilicity of GO sheets. The good dispersion of GO-DDA in other solvents allows it utilization as membrane filler with various types of polymers (PSF, PVDF, PES, PAN, etc.) and for different applications (UF, NF, FO and RO). However, the limited dispersion properties of the pristine GO restrict its usage for such applications.

### Example 6: Characterization of the Prepared Membranes

To investigate the effect of GO incorporation into the PSF matrix, the prepared membranes were characterized using FTIR-UATR. Surface and cross-section (SEM) images were obtained at different magnifications. For the preparation of a cross-section sample, a freeze-fracturing method was used to prevent deformation of the membrane structure by freezing the prepared membranes in liquid nitrogen and fracturing them immediately. Atomic force microscopy (AFM) measurements were performed over 5×5 μm scan area with a scan rate of 1 Hz. The hydrophilicity of the prepared membranes was investigated. Minimum of 15 points of each sample were tested using DIW droplet of 2 μm at room temperature and the average CA value were recorded.

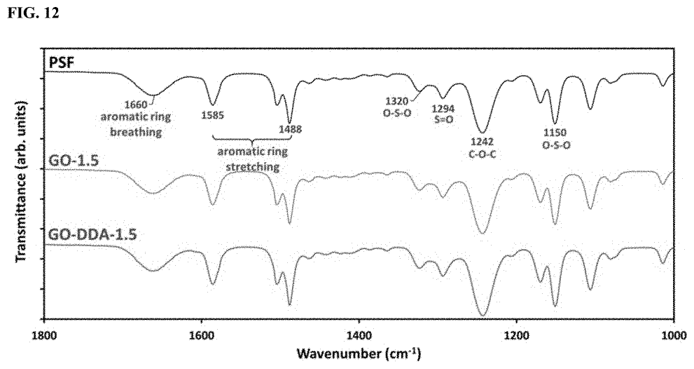

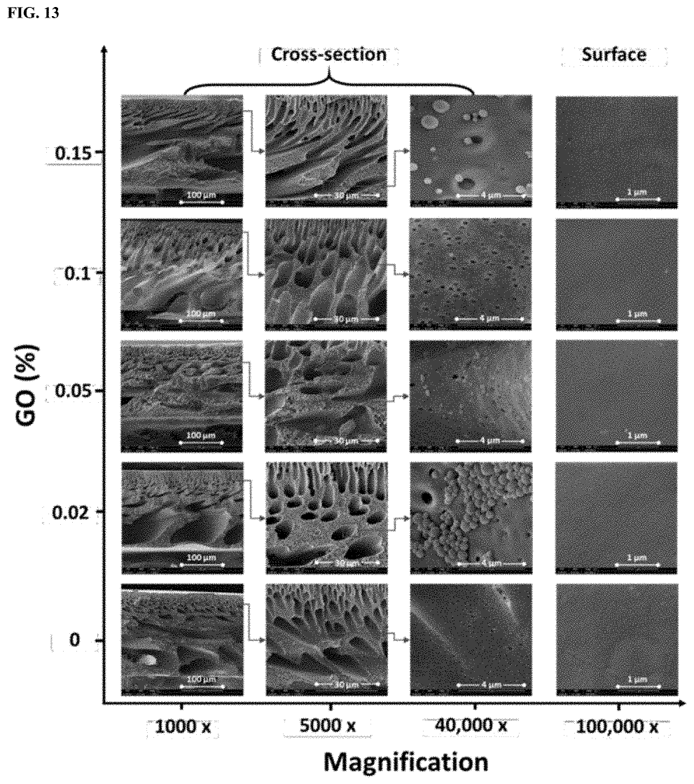

FTIR-UATR: FTIR-UATR spectra of the control PSF, GO-1.5, and GO-DDA-1.5 are shown in FIG. 12. All spectra show the characteristic bands of polysulfone. The following functional groups were identified in the spectra of the prepared membranes: O—S—O symmetric stretching (˜1150 cm⁻¹), C—O—C stretching (˜1242 cm⁻¹), S══O stretching (˜1294 cm⁻¹), O—S—O asymmetric stretching (˜1320 cm⁻¹), C—C aromatic ring stretching (˜1488, 1588 cm⁻¹), and aromatic ring breathing (˜1660 cm⁻¹). No obvious difference was found in the spectra of PSF and PSF composites due to the low concentration of GO and GO-DDA and the dominance of PSF in the membrane matrix.

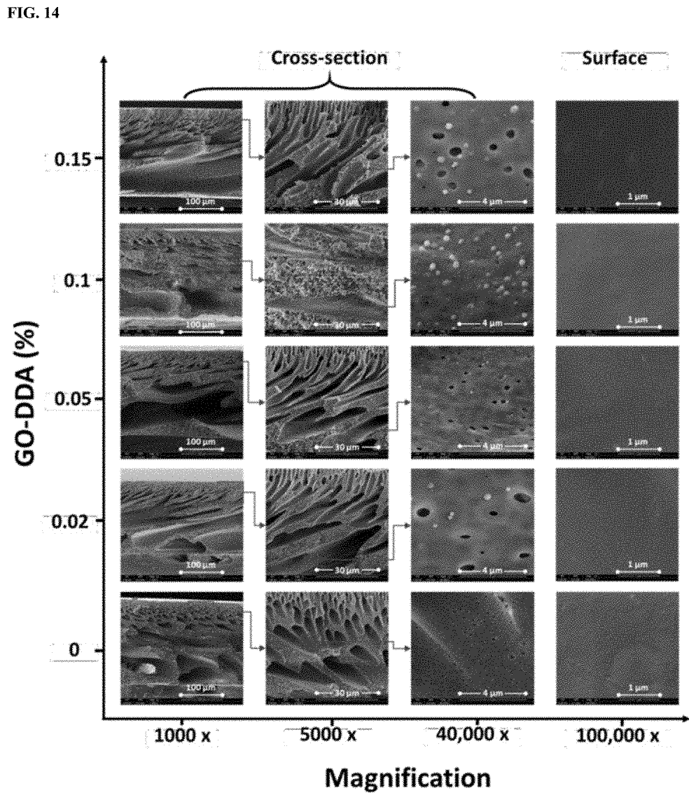

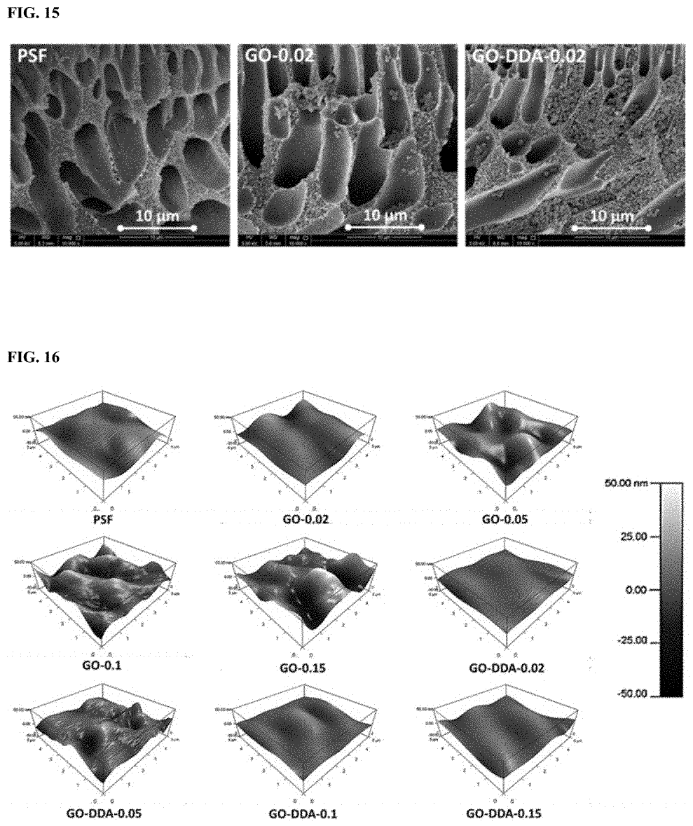

Morphology (SEM & AFM): Surface and cross-section SEM were studied at different magnifications to investigate the effect of GO and GO-DDA incorporation on the PSF structure. FIGS. 13 and 14 show the obtained SEM images with different concentrations of GO and GO-DDA respectively. In both figures, surface SEM does not show significant difference between PSF and composites membranes. The only difference is the darkness of surface that increases with addition of GO or GO-DDA. On the other hand, cross-section SEM showed clear influence of GO and GO-DDA addition on PSF structure. All membranes showed two distinct layers: a thin dense layer on the top and a typical sponge structure sub-layer. The sub-layer consists of several finger-like macro-voids and small pores surrounded by the polymer wall. With the addition of GO, the finger-like macro-voids became longer and wider due to the hydrophilic nature of GO that enhance the mass transfer rate between the solvent (NMP) and non-solvent (DIW) during phase inversion. In contrast, no significant difference in the sub-layer pore structure was observed with the addition of GO-DDA due to its hydrophobic nature as discussed earlier. At high magnifications, it can be clearly seen that both GO and GO-DDA particles are distributed on the polymer wall of the sub-layer. It was also found that nanoparticles are agglomerated in some areas of the sub-layer causing a partial filling of the membrane pores even at low concentrations of GO and GO-DDA as depicted by FIG. 15. This clogging causes a reduction in the water flux through the membrane.

Surface roughness is essential factor that affect separation and fouling resistance of a membrane. Hence, AFM analysis was employed to investigate the effect of GO and GO-DDA addition on membrane roughness. FIG. 16 shows three-dimensional AFM images over 5×5 μm scan area. Roughness parameters represented by the root-mean-square roughness (RMS) and average roughness are listed in Table 4. Surface roughness was found to increase with the high concentrations of GO while it remains the same with low concentrations of GO (e.g., 0.02%). RMS and Ra of pristine PSF were 7.1 and 5.7 nm, respectively, and increased up to 16 and 11.5 nm with 0.15 wt. % GO. When comparing PSF and GO based membranes with GO-DDA based membranes, RMS and Ra were found to decrease with GO-DDA addition indicating that GO-DDA based membrane were apparently smoother than pristine PSF and GO-based membranes. It is well established that membranes with rough surface have higher fouling propensity due to the contaminants accumulation in the valleys while membranes with smoother surface have higher fouling resistance capability.

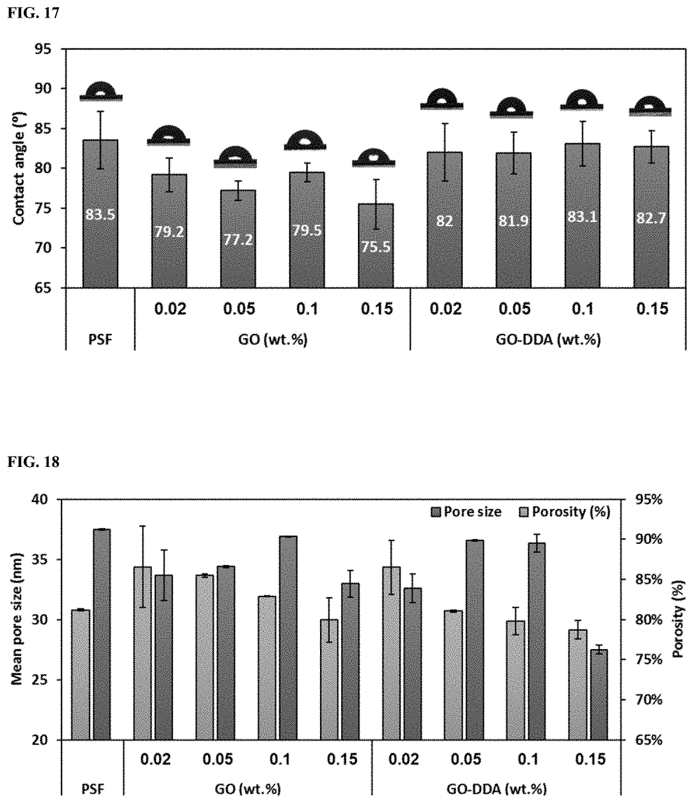

Hydrophilicity, Porosity, and Mean Pore Size: Surface hydrophilicity of the prepared membranes in term of static contact angle (CA) is illustrated in FIG. 17. CA decreased with the addition of GO providing more hydrophilicity to membrane surface. The average CA of pristine PSF was found to be 83.51° while it decreased up to 75.5° with 0.15 wt. % GO, which is related to the hydrophilic nature of GO. In contrast, GO-DDA based membranes exhibited less hydrophilicity than GO based membranes. The average CA of GO-DDA based membranes were close to CA of pristine PSF and were in the range of 81.9°-83.1°. This agrees with the characterization results of GO-DDA that showed a hydrophobic nature of GO-DDA compared to unfunctionalized GO. The effect of GO/GO-DDA incorporation on the overall porosity (ε) and mean pore size (Rₘ) are illustrated in FIG. 18 and Table 4. Low dosage of both GO and GO-DDA, 0.02 wt. %, was found to slightly increase the porosity of PSF from 81.2% to about 86.6% and 86.5% respectively. This can be explained by the increase of mass-transfer rate between solvent (NMP) and non-solvent (DIW) during the phase inversion process caused by the addition of GO and GO-DDA. However, when increasing the concentration to 0.15%, the porosity decreased to 79.9% and 78.7% for GO and GO-DDA respectively. Excessive compositions of nanomaterial increase the viscosity of the casting solution resulting in a delayed de-mixing during the phase inversion process, lower porosity and the formation of smaller pores. The estimated mean pore size of all modified membranes was lower than this of pristine PSF. The mean pore size of pristine PSF was found to be around 37.5 nm while it was ranging between 33-36.9 nm and 27.5-36.6 nm for GO and GO-DDA membranes respectively. This can be explained by the agglomeration of GO/GO-DDA particles inside the pores making a partial blockage as shown by the SEM analysis.

TABLE 4
Water contact angle (CA), porosity (ε), mean
pore size (Rm), root-mean-square roughness (RMS),
and average roughness (Ra) of the prepared membranes.

| | | | Rₘ | RMS | Ra |
|---|---|---|---|---|---|
| Membrane | CA)°( | (%) ε | (nm) | (nm) | (nm) |
| PSF | 3.6 ± 83.51 | 0.1 ± 81.2 | 0.1 ± 37.5 | 7.1 | 5.7 |
| GO-0.02 | 2.1 ± 79.2 | 5.1 ± 86.6 | 2.1 ± 33.7 | 7.0 | 5.7 |
| GO-0.05 | 1.2 ± 77.2 | 0.2 ± 85.5 | 0.1 ± 34.4 | 9.4 | 7.4 |
| GO-0.1 | 1.2 ± 79.5 | 0.1 ± 82.9 | 0.0 ± 36.9 | 13.2 | 10.5 |
| GO-0.15 | 3.1 ± 75.5 | 2.8 ± 79.9 | 1.1 ± 33.0 | 16.0 | 11.5 |
| GO-DDA-0.02 | 3.6 ± 82 | 3.4 ± 86.5 | 1.2 ± 32.6 | 6.3 | 5.2 |
| GO-DDA-0.05 | 2.6 ± 81.9 | 0.1 ± 81.1 | 0.1 ± 36.6 | 7.2 | 5.4 |
| GO-DDA-0.1 | 2.8 ± 83.1 | 1.7 ± 79.8 | 0.8 ± 36.4 | 5.1 | 4.0 |
| GO-DDA-0.15 | 2.0 ± 82.7 | 1.2 ± 78.7 | 0.4 ± 27.5 | 4.9 | 4.1 |

### Example 7: Permeability, Rejection, and Antifouling Measurements

Pure water permeability (PWP), Flux (J), rejection and antifouling properties of the prepared membranes were measured using cross-flow membrane apparatus. The apparatus is equipped with dual testing cells installed in series and temperature control system as well. Flux (J, L·m⁻²h⁻¹), pure water permeability (PWP, L·m² h-1 bar⁻¹) and rejection (R %) were calculated using Equation 1, 2, and 3 respectively

$$J = \frac{V}{A . t} \qquad ( 1 )$$

$$PWP = \frac{Q}{Δ P . A} \qquad ( 2 )$$

$$R ( \% ) = 1 - ( \frac{{C}_{p}}{{C}_{f}} ) \times 100 \qquad ( 3 )$$

Where V is the permeate volume (L), A is the effective membrane area if the membrane (m²), t is the operating time (h), Q is the volumetric flowrate of the permeate (L·h⁻¹), ΔP is the trans-membrane pressure difference, Cₚ and C_{f} are the solute concentration in the permeate and feed respectively. Antifouling properties of the prepared UF membranes were investigated using 500 mg/L BSA and 25 mg/L HA as the model foulants representing protein and organic fouling (each foulant was used separately). In brief, the membrane was compacted with DIW at 4 bar for 30 minutes. The pressure was then reduced to 1±0.1 bar with cross-flow velocity of 46.1±0.3 cm·s⁻¹ and the steady pure water flux was recorded (J_{w0}). The feed is then shifted to freshly prepared foulant solution at the same pressure and cross-flow velocity for 1 hour and the foulant flux (J_{wf}) was recorded then. After foulant filtration, the membrane was washed twice with DIW at the same cross-flow velocity without applied pressure for 30 minutes. Finally, the feed is shifted to pure DIW at 1 bar and the steady flux was recorded (J_{w1}). The total fouling ratio (Rₜ), flux recovery ratio (FRR), the reversible fouling ratio (Rᵣ) and the irreversible fouling ratio (Rᵢᵣ) were estimated by equations 4 to 7 respectively:

$${R}_{t} ( \% ) = \frac{{J}_{w 0} - {J}_{wf}}{{J}_{wo}} \times 100 \qquad ( 4 )$$

$$FRR ( \% ) = \frac{{J}_{w 1}}{{J}_{w 0}} \times 100 \qquad ( 5 )$$

$${R}_{r} ( \% ) = \frac{{J}_{w 1 -} {J}_{wf}}{{J}_{w 0}} \times 100 \qquad ( 6 )$$

$${R}_{ir} ( \% ) = \frac{{J}_{w 0} - {J}_{w 1}}{{J}_{w 0}} \times 100 \qquad ( 7 )$$

The concentration of BSA and HA in the feed and permeate, Cf and Cp, were measured using UV-VIS spectrophotometer (UV-2700, Shimadzu). BSA concentration was measured at 278 nm, while HA concentration was measured at 254 and 280 nm. All PWP, rejection, and antifouling experiments were performed at room temperature (23±0.5° C.).

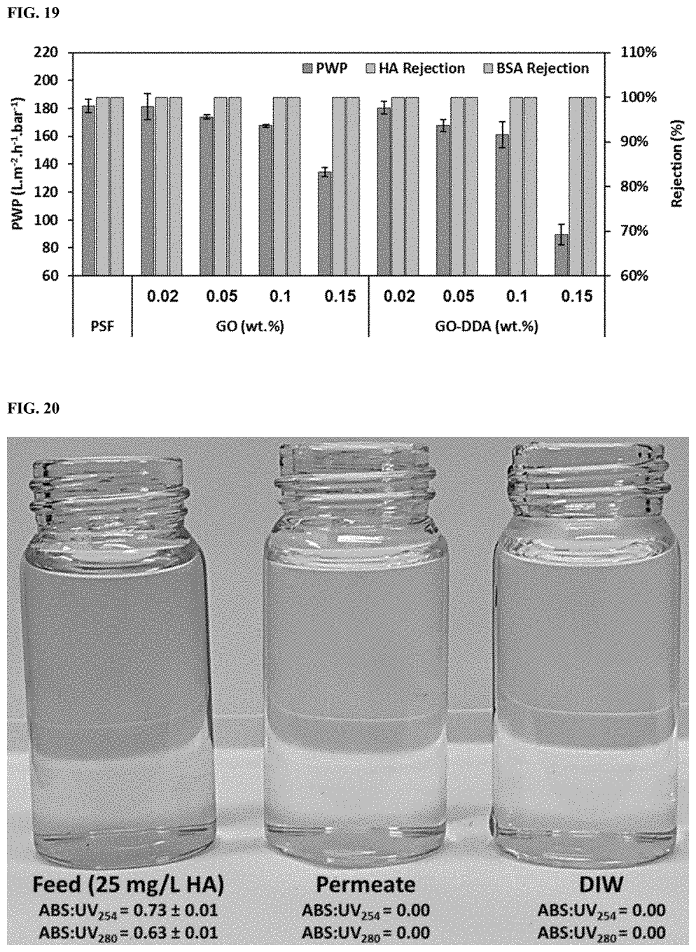

Permeability and separation performance: PWP and separation performance of the prepared membranes are illustrated in FIG. 19. PWP of the pristine PSF was recorded to be 181.7±4.6 L·m⁻²·h⁻¹·bar⁻¹. With low concentration of nanomaterial (0.02 wt. %), PWP has practically not changed. However, with excessive concentrations of the GO and GO-DDA, membranes exhibited higher decreases in PWP. With 0.15 wt. % GO, PWP decreased to 134.3±3.2 L·m⁻²·h⁻¹·bar⁻¹ while the decrease was much higher with 0.15 wt. % GO-DDA (89±7.1 L·m⁻²·h⁻¹). This can be explained by the presence of a tipping mass percentage of nanomaterial. The incorporation of a hydrophilic nanomaterial changes the overall hydrophilicity of the casting solution. This accelerates the exchange of solvent and non-solvent during phase inversion process. However, excessive addition of the nanofiller increases the viscosity of the casting solution leading to a reduction in porosity and pore size as depicted by the results obtained from porosity and pore size measurements. A tipping mass percentage is a critical point after which the permeability decreases as a result of the increase in solution viscosity. The tipping mass percentage varies depending on the type of nanofiller and polymer. Hence, the results in this work suggests a tipping mass percentage <0.02 wt. % for both GO and GO-DDA. Further analysis of the results obtained from PWP, porosity, and hydrophilicity measurements shows that PWP decreases as the porosity decreases regardless of the increase in the surface hydrophilicity. This observation suggests that porosity have more impact on permeability compared to surface hydrophilicity.

As depicted in FIG. 19, all tested membranes exhibited a complete rejection of both BSA and HA (virtually 100%). Commonly, rejection mechanisms in membranes include sieving (size-based), adsorption-based mechanisms, and charge. However, for UF membranes, sieving is considered the key mechanism of rejection. Hence, the rejection of both BSA and HA is mainly a size-based filtration mechanism due to their high molecular weights. FIG. 20 shows photographs of samples the feed and permeate during HA filtration experiments.

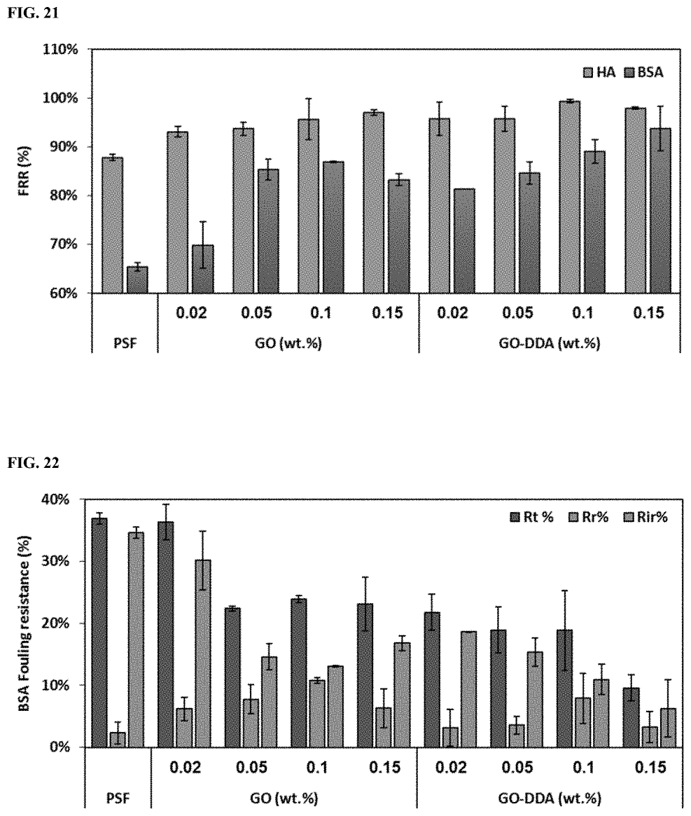

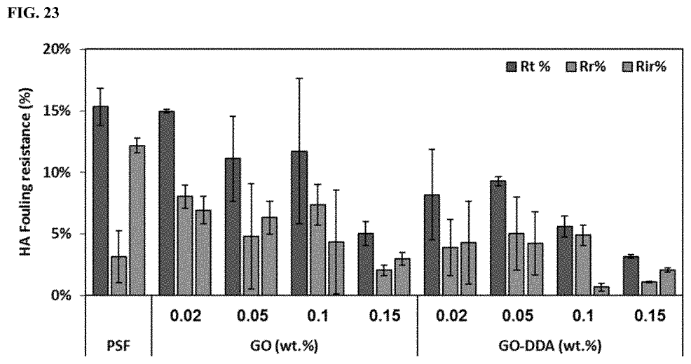

Antifouling Measurements: one of the key properties of a good-performance membrane is the fouling resistance. The filtration process usually leads to the blockage of pores within the membrane, formation of cake layers on the surface and concentration polarization. It was observed that all membranes exhibited a flux decline after switching the feed from pure water to BSA or HA solutions. This may be related to the formation of foulant layers due to the deposition of BSA and HA molecules onto the membranes surface. After 30 minutes of membrane washing with DIW, the pure water flux was partially recovered for all membranes and flux recovery ratio (FRR) was then calculated. Antifouling performance against both foulants (BSA and HA) of the tested membranes represented by flux recovery ratio (FRR) are depicted in FIG. 21. Obviously, all GO and GO-DDA based membranes showed higher FRR compared to pristine PSF that exhibited 65.4±0.9% and 87.8±0.6% with BSA and HA, respectively. For BSA experiments, the maximum FRR was obtained with GO-DDA-0.15 (93.7±4.6%) and with GO-0.1 (86.9±0.1%). When using HA as model foulant, FRR increased up to 97.0±0.5% and 99.3±0.3% with GO-0.15 and GO-DDA-0.1, respectively. For further analysis of the antifouling properties of the tested membranes, Rₜ, Rᵣ and Rᵢᵣ were calculated and presented in FIGS. 22 and 23 for BSA and HA, respectively. Obviously, the total fouling ratio (Rₜ) and the irreversible fouling ratio (Rᵢᵣ) of pristine PSF were higher than all modified membranes and vice versa for the reversible fouling ratio (Rᵣ). These results suggest higher fouling resistance of the modified membranes compared to the pristine PSF due the difference in surface roughness and hydrophilicity.

It is well known that both surface roughness and hydrophilicity affect the antifouling properties of membrane. As discussed earlier, GO-based membranes showed higher surface roughness than neat PSF and GO-DDA based membranes. Hence, in the first stage of fouling, foulant molecules accumulate in the valleys due to surface roughness leading to significant decrease in the flux. During the washing step with DIW, GO particles dispersed in the pores and on the surface enhance the removal of foulants by water due to their hydrophilic nature. Therefore, FRR of all GO-based membranes was recorded to be higher than this of pristine PSF. In contrast, FRR of GO-DDA-based membranes increased due to their smoother surfaces as shown in the results obtained by AFM analysis. Therefore, it can be concluded from these results that antifouling properties were enhanced by the hydrophilicity in case of GO and by the lower surface roughness in case of GO-DDA addition.

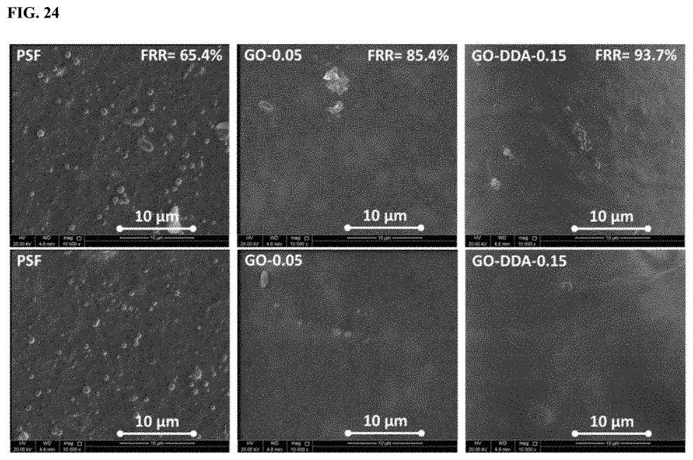

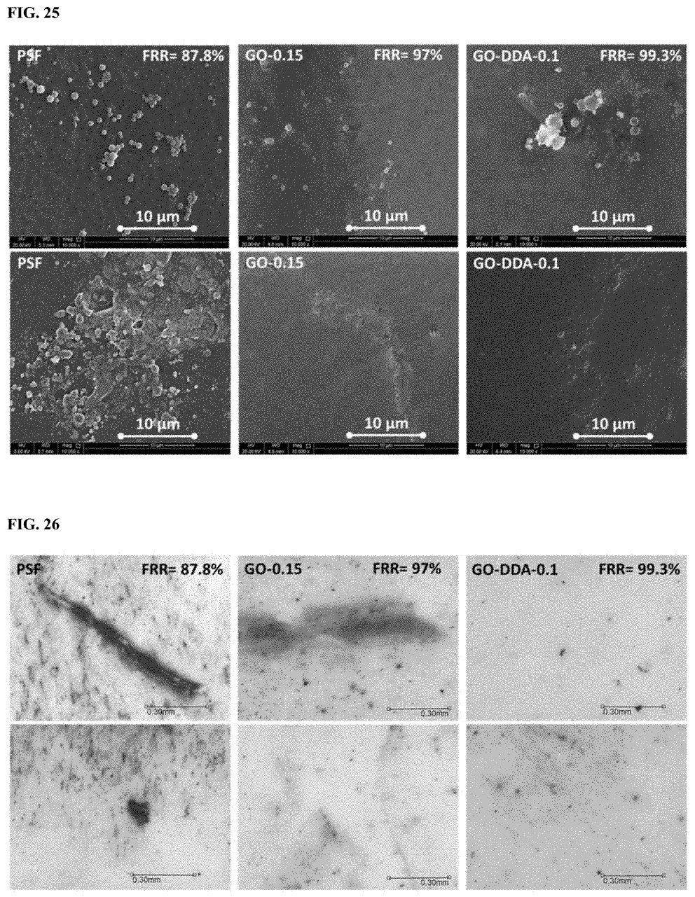

FIGS. 24 and 25 presents SEM images for the fouled membranes at a magnification of 10,000× at two different locations on the surface with BSA and HA, respectively. FIG. 26 shows microphotographs of HA-fouled membranes at two different locations of the surface. Both SEM images and microphotographs confirm the improved fouling resistance of GO and GO-DDA based membranes compared to the pristine PSF.

### Example 8: Porosity and Mean Pore Size Determination

The overall porosity (ε) of the prepared membranes was determined using the gravimetric method as described by Equation 8:

$$ε = \frac{{w}_{w} - {w}_{d}}{A \times l \times ρ w} \qquad ( 8 )$$

Where ww is the weight of the wet membrane (g), wd is the weight of the dry membrane (g), A is the surface area of the membrane (cm²), l is the membrane thickness (cm), and ρw is the water density at 23° C. (0.998 g·cm⁻³). Based on PWP and porosity measurements, mean pore size (rm) was then determined using the Guerout-Elford-Ferry equation (Equation 9):

$${r}_{m} = \frac{\sqrt{( 2.9 - 1.75 ε ) \times 8 η IQ}}{ε \times A \times Δ P} \qquad ( 9 )$$

Where η is the water viscosity at 23° C. (9.3×10⁻⁴ Pa·s), Q is the permeate flow rate (m³·s⁻¹), and ΔP is the operational pressure (Pa).

### Example 9: Antibacterial Activity Measurements

The antibacterial properties of the prepared membranes were investigated by bacteriostasis rate determination using Halomonas aquamarina as the model bacterium. 16 mg of the PSF, PSF-GO and PSF-GO-DDA were cut and washed with ethanol then with DIW to remove ethanol residuals. Membranes were then added to 10 ml of Luria Bertani (LB) solution incubated with appropriate volume of Halomonas to obtain initial optical density of 0.1 at 600 nm (OD600). Samples were then incubated at 30° C. for 18 hours. Membranes were then retrieved from cultures and washed with saline. The wash solution was then diluted with the serial dilution method to get the actual number of cells at the beginning and the end of experiment (t=0 and t=18 h). The number of colonies on each plate was determined using the counting method. Bacteriostasis rate (BR %) was then calculated using Equation 10:

$$BR ( \% ) = \frac{n 0 - n 1}{n 0} \times 100 \% \qquad ( 10 )$$

where n0 is the number of colonies on the plates treated with pristine PSF membrane and n1 is the number of colonies on the plates treated with membranes incorporating GO or GO-DDA.

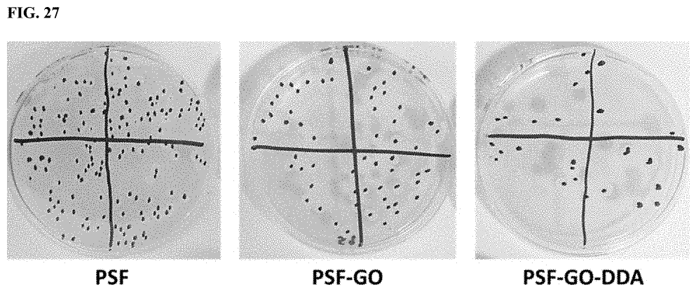

Bacteriostasis rate determination is commonly used to quantitatively analyze the antibacterial activity of membranes. As shown in FIG. 27, the number of bacterial colonies on the pristine PSF plate are much higher than those on hybrid membranes. The lowest number of colonies was observed with GO-DDA. The antibacterial rate of PSF-GO membrane was 62.9% which is much lower than this of PSF-GO-DDA (83.6%). The results of this work demonstrate that the functionalization with DDA improved the antibacterial activity of GO and inhibited the growth of bacteria on membranes.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A process of synthesizing graphene oxide (GO) with high oxygen content and NOx-free emissions starting from natural graphite flakes, the process comprising:
(i) mixing sulfuric acid (H₂SO₄) and phosphoric acid (H₃PO₄),
(ii) adding graphite powder and potassium permanganate (KMnO₄),
(iii) transferring the mixture to an oil bath,
(iv) adding deionized water (DIW) to the mixture,
(v) adding H₂O₂,
(vi) cooling down the mixture at room temperature,
(vii) diluting the mixture with a HCl solution, and
(viii) performing centrifugation.

2. The process of claim 1, wherein volumes of the H₂SO₄ and the H₃PO₄ mixed in step (i) is about 24 ml and about 6 ml, respectively.

3. The process of claim 1, wherein amounts of the graphite powder and the potassium permanganate added in step (ii) are about 1 g and about 3 g, respectively.

4. The process of claim 1, wherein a volume of the DIW added in step (iv) is 50 ml.

5. The process of claim 1, wherein a volume of the H₂O₂ added in step (v) is about 10 ml.

6. The process of claim 1, wherein the centrifugation in step (viii) is repeated.

7. A process of functionalizing GO with dodecylamine (DDA), the process comprising:
(i) dispersing GO in DIW and DDA in ethanol to form suspensions,
(ii) sonicating the suspensions, and
(iii) extracting a functionalized GO (GO-DDA).

8. The process of claim 7, wherein in step (i), about 100 mg of GO is dispersed in about 50 ml of DIW, and about 300 mg of DDA is dispersed in about 50 ml of ethanol.

9. The process of claim 7, wherein the GO-DDA comprises at least one functional group selected from the group consisting of C—O—C, C—OH, C═O, and C═C.

10. A process of preparing a membrane, the process comprising:
(i) adding GO-DDA to 1-Methyl-2-pyrrolidinone (NMP) to form a mixture,
(ii) mixing polyvinylpyrrolidone (PVP) and polysulfone (PSF) in the mixture, and
(iii) casting the mixture to form the membrane, wherein the membrane comprises PSF-GO-DDA.

11. The process of claim 10, wherein in step (ii), a concentration of the PVP is 3 wt. % in the NMP, and a concentration of the PSF is about 17 wt. % in the NMP.

12. The process of claim 10, wherein the membrane comprises at least one functional group selected from the group consisting of C—S—O, C—O—C, S═O, and C—C aromatic ring.
